(19) United States
(12) Patent Application Publication
(10) Pub. No.: US 2021/0168181 A1
(43) Pub. Date: Jun. 3, 2021

(54) A Media Streaming System Compatible with Content Distribution Networks

(71) Applicant: Medianova Internet Hizmetleri Ve Ticaret Anonim Sirketi, Sisli/Istanbul (TR)

(72) Inventor: Serkan SEVIM, Istanbul (TR)

(73) Assignee: Medianova Internet Hizmetleri Ve Ticaret Anonim Sirketi, Sisli/Istanbul (TR)

(21) Appl. No.: 17/267,832

(22) PCT Filed: Sep. 13, 2019
(86) PCT No.: PCT/TR2019/050750

§ 371 Date: Feb. 11, 2021

(30) Foreign Application Priority Data
Jun. 21, 2019 (TR) 2019/09266

(51) Int. Cl. H04L 29/06; H04N 21/24; H04N 21/258

(52) U.S. Cl. CPC H04L 65/4069; H04N 21/2402; H04N 21/2407; H04L 63/107; H04N 21/25841; H04L 63/0807; H04N 21/2408

(57) ABSTRACT

The invention is an algorithm that works in compatible with content distribution networks, solves the problem of audio & video synchronization and optimizes resource usage by increasing the volume of network traffic comprises the steps: -Receiving the request (http) from the end user (12) (1001), -Checking the token information validity (1002), -If the token information is valid, it is checked whether a geoblock is applied for the requested content (1003). -If there is a geoblock for the content, querying whether the country, from which the user made the content request, is in the geoblock list (1004), -If no geoblock is applied for the content or the user making the request is not in restricted countries even if it is applied, NGINX over the SSM Edge servers (9) is activates for obtaining the content requested and the content is obtained (1005), -SSM (6) sub-modules start working in parallel (1006), -Arranging the manifest (1007), -Preparation of analytical data (1008), -Preparation of the response (1009) and -Sending the response (1011) to the end user (12).

### TECHNICAL FIELD

The invention provides a media streaming application that is compatible with content distribution networks. This invention solves the resulting audio and video synchronization problem during application and optimizes resource utilization by increasing the volume of network traffic.

### PRIOR ART

In older systems, edge and origin servers within CDN Points of Presence (PoP) respond to end users with media streaming applications such as WOWZA. These WOWZA streaming applications are having trouble responding to tens of thousands of requests. In order to solve the problem, it is necessary to add new devices to the system continuously. There is an obligation to pay new license fees depending on the addition of new devices.

Today's Media streaming applications are costly and in addition to audio and video synchronization problems when responding to evolving video content requests, they become incapable for responding to a certain traffic volume although the resource utilization efficiency is low.

WOWZA, the world's most widely accepted media streaming application used by Content Distribution Networks (CDN) and service providers; supports streaming types in many different formats such as RTMP, HLS, MDASH and HDS. It also offers advanced user monitoring and media streaming management.

Despite all the conditions, WOWZA is unable to meet the performance needs of network infrastructures which are developing day by day with its Java based complex structure. Existing WOWZA-containing media streaming applications can reach a traffic volume of 1.5-2 Gbps per device under heavy load. In addition, video and audio synchronization mismatches occur at such load densities.

Broadcasting live over the Internet and broadcasting this live broadcast in all browsers and environments is costly. This high cost is due to license fees or fees charged per hour.

### PURPOSE OF THE INVENTION

The object of the invention is to create a platform for enhancing the end user responsiveness of existing media streaming applications.

Another purpose of the invention is to achieve a more stable, agile, simple media streaming application.

Another purpose of the invention is to increase traffic volume without compromising performance at high traffic densities of media streaming applications.

Another purpose of the invention is to provide solutions for traffic based license fees.

Another purpose of the invention is to provide video and audio synchronization during broadcasting.

Another purpose of the invention is to provide a much higher performance by creating a platform that is not complex unlike other applications and meets the basic requirements.

A media streaming application that is compatible with content distribution networks developed to achieve the said objectives is composed of these process steps; receiving the request (http) from the end user (1001), checking token information validity (1002), querying whether a Geoblock is applied to the requested content if the token information is valid (1003), if there is a Geoblock for the content, querying whether the whether the country, from which the user made the content request, is in the geoblock list (1004), if no geoblock is applied for the content or the user making the request is not in restricted countries even if it is applied, activation of NGINX (reverse proxy software) over the Edge servers (9) for obtaining the content requested and obtaining the content (1005), starting of the SSM (6) modules to run in parallel (1006), issuance of the manifest (1007), Preparation of the analytical data (1008), preparation of the response (1009) and sending the response to the end user (1011).

### DESCRIPTION OF FIGURES

Attached FIG. 1 illustrates the system architecture.

FIG. 2 illustrates the simple streaming module.

FIG. 2 illustrates the flow diagram showing the operation of the simple streaming module.

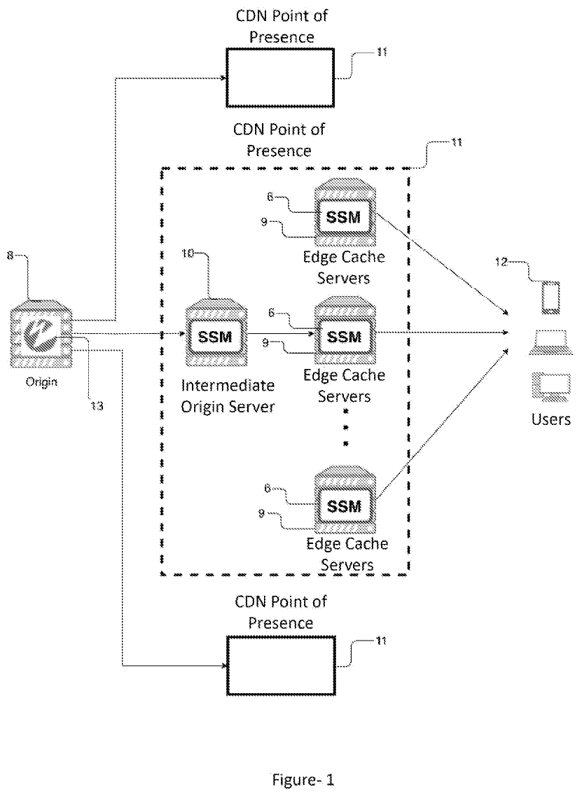

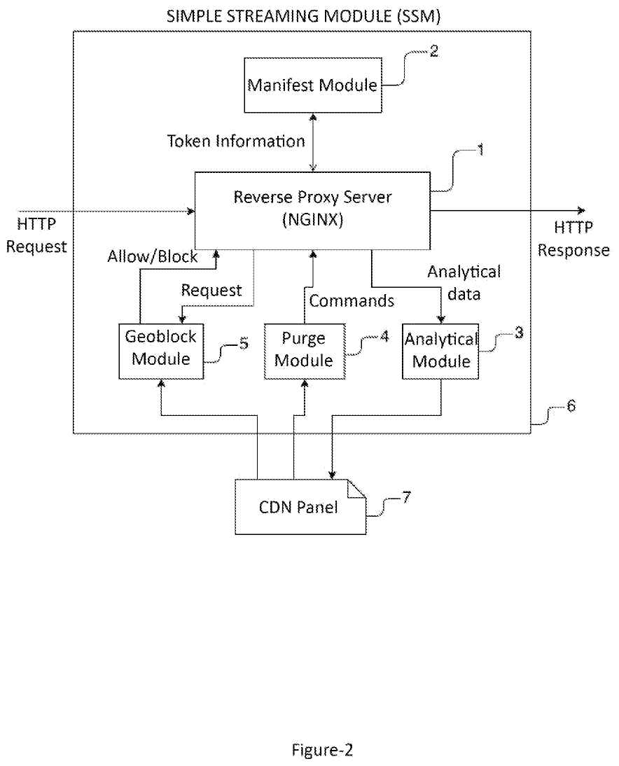

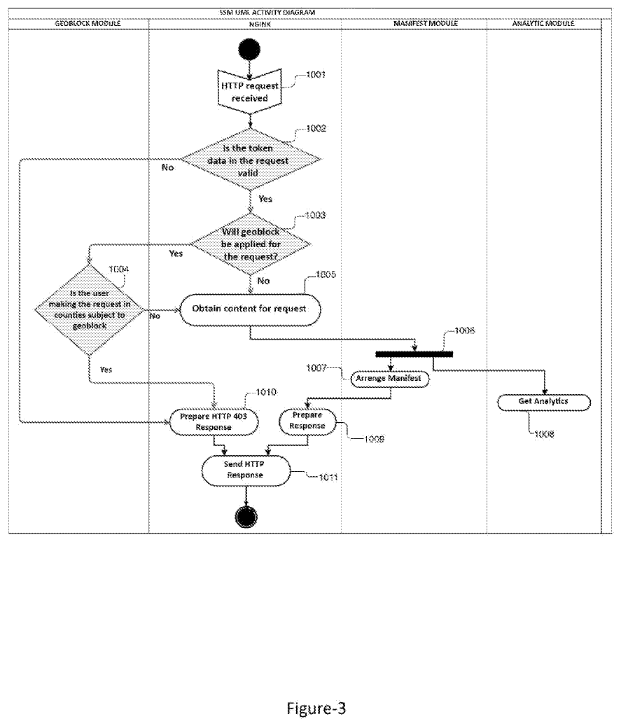

Numbers and names of main parts mentioned in the figures are given below.
(1) NGINX Web Server
(2) Manifest Module
(3) Analytical Module
(4) Purge Module
(5) Geoblock Module
(6) Simple Streaming Module (SSM)
(7) CDN Panel
(8) Origin Server (origin)
(9) SSM Edge Server
(10) Intermediate Origin Server (intermediate origin)
(11) CDN Point of Presence (PoP)
(12) End user
(13) Current Broadcast Streaming Applications

### DETAILED EXPLANATION OF THE INVENTION

This invention provides a media streaming application that is compatible with content distribution networks. This invention solves the resulting audio and video synchronization problem during application and optimizes resource utilization by increasing the volume of network traffic.

A new broadcast streaming platform has been developed with Simple Streaming Module (SSM) (6) to achieve low cost, high traffic rates for streaming video on CDNs. A CDN video streaming platform with SSMs (6) is shown in FIG. 1. The main objective here is to improve the performance by responding to end users (12) with SSM (6) developed in the content of PoP (11) and to avoid the extra cost for new devices.

SSM (6), which is the key element of our platform, is located in Edge (9) and intermediate origins (10), on the PoP (11). Requests from users (12) are answered by Edge Cache Servers (9). The edge Cache servers (9) continuously update their contents from intermediate origins (10) to provide the most up-to-date responses to requests. Intermediate origins (10) provide the fastest content to end users (12) by periodically checking new content situation over the origin (8). Our system hosts existing media streaming applications (13) such as WOWZA only on this origin (8). Since these origins (8) do not respond to user requests but they respond to content requests received from PoP (11) caches, they needed to deal with hundreds of requests instead of ten thousands. Thus, the problems experienced in the current art are avoided.

The simple streaming module (SSM) (6) responds to end-user requests to CDNs, thus simplifies the media streaming process and improves performance. Here, the HTTP request is met by NGNIX web servers (1). SSM (6) sub-modules operate in parallel (1006) while responding to requests with the developed software. These modules are manifest module (2), analytical module (3), purge module (4) and geoblock modules (5). These modules, which work with the algorithm developed in connection with the CDN Panel (7), can both be controlled from this panel and send reports to the panel.

The developed algorithm works as follows; The token information validity (1002) is checked for requests (1001) from the end user (12), and if the token information is invalid, an error message (http 403 error) is returned (1010). If the token information is valid, it is checked whether a geoblock is applied for the requested content (1003). If there is a Geoblock for the content, querying whether the whether the country, from which the user made the content request, is in the geoblock list (1004) If the user is in the list of countries subject to geoblock, an error message (http 403 error) is returned (1010). If no geoblock is applied for the content or the user making the request is not in restricted countries even if it is applied, NGINX (reverse proxy software) over the Edge servers (9) is activates for obtaining the content requested and the content is obtained. (1005) SSM (6) sub-modules start to run at this stage. In parallel (1006), manifest arrangement (1007) and analytical information preparation (1008) are performed at this stage. The response is prepared (1009) and sent to the end user (12) (1011). After the content is cached on the edge servers (9), each server is now able to respond to thousands of requests for the same content from the cache without needing to access Wowza. The Wowza origin server is no longer able to respond to thousands of requests and can easily respond to the requests of SSM modules only on the edges (9).

In this system designed, existing media streaming applications will only respond to the requests of intermediate origins in the servers network located at the point of presence, thus run without any performance loss by responding to a few requests rather than tens of thousands. The Nginx based live streaming module under the invention, operates in a wider traffic volume compared to the existing systems as it operates more smoothly in heavy traffic.

The definitions of the servers and modules used in the application are as follows; The NGINX web server (1) is the web server to be used to make the media streaming application run faster. The manifest module (2) adds token URL information to the end of the files with the extension m3u8 and ts. The analytical module (3) analyzes and reports information such as the number of times the content is viewed and the duration. The purge module (4) allows the contents to be cleaned. The Geoblock Module (5) performs geo-broadcast blocking. Simple Streaming Module (SSM) (6) is the main module that performs the media streaming application. The CDN Panel (7) is the panel that provides control of the CDN consisting of geographically distributed servers. Origin Servers (8) are servers where the content is received from clients and adapted to the CDN. One of the existing applications is used as the media streaming application. SSM Edge Server (9), responds to end user (12) requests with SSM installed on edge servers. Intermediate Origin Server (10) serves content to the edge servers (9) by making requests to the Origin servers (8) at their points of presence. CDN point of presence (PoP) (11); asset points are the key element of geographically distributed CDN architecture. It hosts servers and software and acts between end users (12) and origins. The end user (12) is the user who is making the content request. Existing broadcast streaming applications are users who perform the content request.

The technical problems are solved by defining a module called “Simple Streaming Module (SSM)” (6) to the servers in the points of presence (PoP) that respond to end users (12). The SSM (6) operates on four modules. These modules respond to requests with the help of the algorithm developed on the NGINX web server (1) software. The four modules running on the SSM (6) and their descriptions are given below:

1—Analytical Module (3): The data received is read from the database and the statistical data such as the number of viewers (hits), traffic consumed, bandwidth consumed (bandwidth) for each user is displayed through the interface designed to display the analysis of the module developed.

2—Geoblock Module (5): The GeoIP database file from Maxmind is integrated into the NGINX Web server (1) in order to determine the Geoblock access permissions for controlling the limited time interval. Said geoblock module (5) is developed in the Perl programming language within the control of Geolocation information to meet user requests.

3—Purge Module (4): Thanks to this module developed, VoD HLS chunks can be read and deleted from the related m3u8 file in order to purge.

4—Manifest Module (2): It is a module written in C programming language and integrated in current servers, which adds the token URL at the end of m3u8 and ts files for the requests made by the users from the streaming platform to the origin in Live and VoD streaming platforms.

The invention is an algorithm that works in compatible with content distribution networks, solves the problem of audio & video synchronization and optimizes resource usage by increasing the volume of network traffic; which is characterized as containing following process steps;
Receiving the request (http) from the end user (12) (1001),
Checking the token information validity (1002),
If the token information is valid, it is checked whether a geoblock is applied for the requested content (1003).
If there is a Geoblock for the content, querying whether the whether the country, from which the user made the content request, is in the geoblock list (1004),
If no geoblock is applied for the content or the user making the request is not in restricted countries even if it is applied, NGINX (reverse proxy software) over the Edge servers (9) is activates for obtaining the content requested and the content is obtained (1005),
SSM (6) sub-modules start working in parallel (1006),
Arranging the manifest (1007),
Preparation of analytical data (1008),
Preparation of the response (1009) and
Sending the response (1011) to the end user (12).

1. An algorithm that works in compatible with content distribution networks, solves the problem of audio & video synchronization and optimizes resource usage by increasing the volume of network traffic comprising following process steps,
receiving a request (http) from an end user,
checking a token information validity,
if the token information is valid, it is checked whether a geoblock is applied for the requested content,
if there is a Geoblock for the content, querying whether the country, from which the user made the content request, is in a geoblock list,
if no geoblock is applied for the content or the user making the request is not in restricted countries even if it is applied, NGINX (reverse proxy software) over SSM Edge servers is activated for obtaining the content requested and the content is obtained,
SSM sub-modules start working in parallel,
arranging a manifest,
preparation of analytical data,
preparation of a response and
sending the response to the end user.

2. The algorithm of claim 1, wherein the algorithm returns an error message (http 403 error) if the token information is invalid as a result of the token information validity checking.

3. The algorithm of claim 1, wherein the algorithm queries if there is a Geoblock for the content, whether the country, from which the user made the content request, is in the geoblock list and if such user in the list of the countries subject to geoblock, returns the error message (http 403 error).

4. The algorithm of claim 1, wherein the SSM contains an analytical module, geoblock module purge module and manifest module on the SSM used in troubleshooting technical problems by identifying servers at asset point of Presence (PoP) that respond to end users and working in integration with reverse proxy software (here NGINX).

5. The algorithm of claim 4, wherein the manifest module adds the token URL at the end of m3u8 and ts files for the requests made by the users from the streaming platform to the origin in Live and VoD streaming platforms.

6. The algorithm of claim 4, wherein the data received is read from a database and the statistical data such as the number of viewers (hits), traffic consumed, bandwidth consumed (bandwidth) for each user is displayed through the interface designed to display the analysis of the module developed.

7. The algorithm of claim 4, wherein VoD HLS chunks can be read and deleted from related m3u8 file in order to purge.

8. The algorithm of claim 4, wherein the geoblock module is developed in the Perl programming language within the control of Geolocation information to meet user requests, wherein a GeoIP database file from Maxmind is integrated into the NGINX Web server order to determine the Geoblock access permissions for controlling the limited time interval.
